(19) United States
(12) Patent Application Publication
(10) Pub. No.: US 2024/0043963 A1
(43) Pub. Date: Feb. 8, 2024

(54) APPARATUS AND METHOD FOR METAL EXTRACTION

(71) Applicant: USA Rare Earth, LLC, Tampa, FL (US)

(72) Inventors: Juan Illescas, Denver, CO (US); Reilly West, Lakewood, CO (US); Mathew Laureano, Wheat Ridge, CO (US)

(73) Assignee: USA Rare Earth, LLC, Tampa, FL (US)

(21) Appl. No.: 18/364,387

(22) Filed: Aug. 2, 2023

Related U.S. Application Data
(60) Provisional application No. 63/394,524, filed on Aug. 2, 2022.

(51) Int. Cl. C22B 59/00; C22B 3/44; C22B 60/02; C22B 21/00; C22B 34/14; C22B 26/12; C22B 3/24

(52) U.S. Cl. CPC C22B 59/00; C22B 3/44; C22B 60/0265; C22B 60/0291; C22B 21/0015; C22B 34/14; C22B 26/12; C22B 3/24

(57) ABSTRACT

A method for separating a rare earth metal. The method comprises contacting a solution comprising a rare earth metal with a first column to separate the rare earth metal into light, medium, and/or heavy rare earth metals; and contacting the light, medium, and/or heavy rare earth metals to with the second column to separate the light, medium, and/or heavy rare earth metals into individual rare earth metals. A method for extracting rare earth metals from a solution comprising contacting the rare earth metal with a plurality of resins. A method of extraction rare earth metal and lithium from a dynamic pad and permanent pad.

### CROSS REFERENCE TO RELATED APPLICATIONS

This application claims priority to and the benefit of filing of U.S. Provisional Patent Application No. 63/394,524, entitled APPARATUS AND METHOD FOR METAL EXTRACTION, filed on Aug. 2, 2022, and the specification thereof is incorporated herein by reference.

### BACKGROUND OF THE INVENTION

### Field of the Invention (Technical Field)

Embodiments of the present invention relate to an apparatus and method for metal extraction, in particular for rare earth metals and lithium.

### DESCRIPTION OF RELATED ART

Rare earth metals (“REMs”) are used in the production and manufacture of electronics ranging from televisions and cellular phones to advanced electromagnets used in combat aircraft. These metals have become increasingly important for complex technologies and for global electrification. Demand for REMs as well as lithium has also increased due to the proliferation of electric vehicles and electronics throughout the developing world. What is needed is an economical process to extract and purify REMs and lithium to increase supply and meet the ever-increasing demand for these metals.

### BRIEF SUMMARY OF EMBODIMENTS OF THE PRESENT INVENTION

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention.

### BRIEF DESCRIPTION OF THE SEVERAL VIEWS OF THE DRAWINGS

Embodiments of the present invention relates to a method for separating rare earth metals, the method comprising: contacting a first plurality of rare earth metals with a first resin; contacting the first plurality of rare earth metals with a first chelating agent; separating the first plurality of rare earth metals into a second plurality of rare earth metals; contacting the second plurality of rare earth metals with a second resin; contacting the second plurality of rare earth metals with a second chelating agent; and separating the second plurality of rare earth metals into individual rare earth metals.

In another embodiment, the least one of the plurality of rare earth metals comprises a light rare earth metal. In another embodiment, the least one of the individual rare earth metals comprises a light rare earth metal. In another embodiment, the plurality of rare earth metals comprises a medium rare earth metal. In another embodiment, the at least one of the individual rare earth metals comprises a medium rare earth metal. In another embodiment, the at least one of the plurality of rare earth metals comprises a heavy rare earth metal. In another embodiment, the at least one of the individual rare earth metals comprises a heavy rare earth metal.

In another embodiment, the first plurality of rare earth metals is separated into light and heavy rare earth metals. In another embodiment, the first plurality of rare earth metals is separated into medium rare earth metals. In another embodiment, the first resin is in communication with the second resin. In another embodiment, the first resin is part of a primary carousel system. In another embodiment, the second resin is part of a secondary carousel system. In another embodiment, the first chelating agent comprises ethylenediaminetetraacetic acid. In another embodiment, the second chelating agent comprises ethylenediaminetetraacetic acid.

Embodiments of the present invention also relate to a method for extracting rare earth metals, the method comprising: contacting a solution comprising a rare earth metal with a primary amine resin; contacting the solution with a cation resin; contacting the solution with an N,N,N′,N′-tetra-n-octyldiglycolamine resin; and extracting a rare earth metal from the N,N,N′,N′-tetra-n-octyldiglycolamine resin.

In another embodiment, the cation resin is a strong acid cation resin. In another embodiment, the method further comprises extracting uranium from the primary amine resin. In another embodiment, the method further comprises extracting thorium from the primary amine resin. In another embodiment, the method further comprises extracting aluminum from the cation resin. In another embodiment, the method further comprises extracting a monovalent metal ion from the cation resin. In another embodiment, the method further comprises separating impurities from the rare earth metals. In another embodiment, the primary amine resin comprises a quaternary amine group. In another embodiment, the N,N,N′,N′-tetra-n-octyldiglycolamine resin has an efficiency of at least 80%. In another embodiment, the method further comprises eluting a rare earth metal from the N,N,N′,N′-tetra-n-octyldiglycolamine resin. In another embodiment, the method further comprises extracting a metal from the primary amine resin. In another embodiment, the metal comprises hafnium.

Embodiments of the present invention also relate to a method for extracting a metal, the method comprising: at least partially disposing a material into a first cavity of a dynamic pad; contacting the material at least partially disposed within the first cavity of the dynamic pad with an acid; extracting a rare earth metal from the material at least partially disposed within the first cavity of the dynamic pad; at least partially disposing the material into a second cavity of the dynamic pad; contacting the material at least partially disposed within the second cavity of the dynamic pad with the acid; and extracting a rare earth metal from the material at least partially disposed within the second cavity of the dynamic pad.

In another embodiment, the method further comprises at least partially disposing the material in a permanent pad. In another embodiment, the method further comprises contacting the material at least partially disposed within the permanent pad with the acid. In another embodiment, the method further comprises extracting lithium from the material at least partially disposed within the permanent pad. In another embodiment, the rare earth metal is extracted into a reclamation pond. In another embodiment, the lithium is extracted into a reclamation pond. In another embodiment, the dynamic pad is in communication with the permanent pad. In another embodiment, the method further comprises flowing the acid from the second cavity of the dynamic pad to the first cavity of the dynamic pad. In another embodiment, the method further comprises flowing the acid from the permanent pad to the second cavity of the dynamic pad. In another embodiment, the material at least partially disposed in the first cavity of the dynamic pad is contacted with the acid for approximately 1 to 30 days. In another embodiment, the material at least partially disposed in the second cavity of the dynamic pad is contacted with the acid for approximately 1 to 90 days. In another embodiment, the material at least partially disposed in the permanent pad is contacted with the acid for approximately 1 to 120 days.

Embodiments of the present invention also relate to a method for separating lithium, the method comprising: contacting an acid extraction product with a selective membrane to form a metal ion and hydrogen ion product; precipitating aluminum from the metal ion and hydrogen ion product; adjusting a pH value of the metal ion and hydrogen ion product to form a metal ion solution; contacting the metal ion solution with a lithium-selective sorbent; and forming a lithium ion solution.

In another embodiment, the method further comprises contacting the metal ion and hydrogen ion product with a caustic. In another embodiment, the method further comprises concentrating the metal ion solution. In another embodiment, the method further comprises separating a rare earth metal from the metal ion and hydrogen ion product. In another embodiment, the metal ion and hydrogen ion product comprises lithium. In another embodiment, the method further comprises contacting the metal ion and hydrogen ion product with a hydrogen ion-selective membrane. In another embodiment, the method further comprises contacting the hydrogen ion with the acid extraction product.

Embodiments of the present invention also relate to a method for precipitating aluminum, the method comprising: concentrating a solution comprising lithium, aluminum, and sulfate; crystallizing the solution; precipitating aluminum; forming a precipitation effluent comprising lithium; and separating the precipitation effluent from the precipitated aluminum.

In another embodiment, the concentrating comprises evaporating. In another embodiment, the aluminum precipitates as aluminum sulfate. In another embodiment, the crystallizing comprises decreasing the temperature of the solution. In another embodiment, the temperature is decreased to a temperature of approximately 2° C. to 10° C.

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a process flow diagram showing the extraction of rare earth metal and lithium, according to an embodiment of the present invention;

FIG. 2 is a process flow diagram showing a metal extraction process from a mineral, according to an embodiment of the present invention;

FIG. 3 is a process flow diagram showing extraction of a rare earth metal from a refined acid extraction product, according to an embodiment of the present invention;

FIG. 4 is a process flow diagram showing lithium extraction from acid extraction product from a mineral, according to an embodiment of the present invention;

FIG. 5 is a process flow diagram showing the separation of rare earth metals using a carousel system, according to an embodiment of the present invention;

FIG. 6 is an illustration showing a carousel system for metal separation, according to an embodiment of the present invention;

FIG. 7 is an illustration showing a carousel system for metal separation, according to an embodiment of the present invention;

FIG. 8 is an illustration showing a column separation system, according to an embodiment of the present invention;

FIG. 9 is an illustration of a selective membrane filter system, according to an embodiment of the present invention;

FIG. 10 is a process flow diagram of an aluminum precipitation reaction, according to an embodiment of the present invention;

FIG. 11 is a diagram of an embodiment of a rare earth metal and lithium extraction and processing system, according to an embodiment of the present invention;

FIG. 12 is a diagram of an embodiment of a rare metal earth metal and lithium extraction and processing system, according to an embodiment of the present invention;

FIG. 13 is a diagram of an embodiment of a rare earth metal and lithium extraction and processing system, according to an embodiment of the present invention;

FIG. 14 is a diagram of an embodiment of a rare earth metal and lithium extraction and processing system, according to an embodiment of the present invention; and

FIG. 15 is a process flow diagram showing a two-stage lithium extraction from a mineral, according to an embodiment of the present invention.

### DETAILED DESCRIPTION OF THE INVENTION

The present invention relates to an apparatus and method for rare earth metal separation, the method comprising: contacting a material comprising a rare earth metal with an acidic solution to produce a first product; contacting the acid extraction product with a filter to produce a second product; contacting the first product with a primary amine resin to produce a third product; contacting the third product with strong acid cation resin to produce a fourth product; and contacting the fourth product with a N,N,N′,N′-tetra-n-octyldiglycolamine resin to produce a fourth product comprising a rare earth metal.

The present invention also relates to an apparatus and method of lithium and/or rare earth extraction from a material, the method comprising: at least partially disposing a mineral into a first cavity of dynamic pad; contacting the mineral at least partially disposed within the first cavity of the dynamic pad with an acid; extracting a rare earth metal from the mineral at least partially disposed within the first cavity of the dynamic pad; at least partially disposing the mineral into a second cavity of a dynamic pad; contacting the mineral at least partially disposed within the second cavity of the dynamic pad with the acid; extracting a rare earth metal from the mineral at least partially disposed within the second cavity of the dynamic pad; at least partially disposing the mineral into a permanent pad; contacting the mineral at least partially disposed within the permanent pad with the acid; and extracting lithium from the mineral at least partially disposed within the permanent pad.

The present invention also relates to an apparatus and method of lithium extraction from a solution, the method comprising: contacting a solution comprising lithium, a lithium compound, and/or a lithium ion with a selective membrane to form a product comprising monovalent metal ions; precipitating aluminum from the product comprising monovalent metal ions; adjusting the pH of the product comprising monovalent metal ions; concentrating the product comprising monovalent metal ions; and contacting the product comprising monovalent metal ions with a lithium-selective sorbent to form a product comprising lithium ions. Adjusting the pH of the product comprising monovalent metal ions may comprise contacting the product comprising monovalent metal ions with a hydrogen-ion selective membrane; a base and/or caustic; or a combination thereof.

The present invention also relates to an apparatus and method for selectively extracting a rare earth metal, the method comprising: contacting a solution comprising a rare earth metal with a primary (e.g., first) carousel and/or column, the primary carousel and/or column comprising at least one sorbent at least partially disposed in at least one column; contacting the solution with at least one chelating agent; separating the solution into a first fraction comprising a light rare earth metal, a second fraction comprising a medium rare earth metal, and a third fraction comprising a heavy rare earth metal; contacting each fraction with a secondary (e.g., second) carousel and/or column comprising at least one sorbent at least partially disposed in at least one column; contacting each fraction with a second chelating agent; and separating each fraction into a rare earth metal. Optionally, the first fraction may be contacted with a second chelating agent, the second fraction may be contacted with a third chelating agent, and/or the third fraction may be contacted with a fourth chelating agent.

The terms “metal” or “metals” are defined herein as a compound, mixture, or substance comprising a metal atom. The term “metal” or “metals” includes, but is not limited to, metal hydroxides, metal oxides, metal salts, elemental metals, metal ions, non-ionic metals, minerals, or a combination thereof.

The term “acid extraction” is defined herein as contacting a material with an acid to extract an ion, atom, element, metal, mineral, compound, or other material, or a combination thereof.

The term “product” is defined herein as an output from a process, reaction, method, and/or step, including, but not limited to, a solid, liquid, gas, ion, element, compound, solution, mixture, or a combination thereof.

The term “acid extraction product” is defined herein as a product from an acid extraction. The term “acid extraction product” includes, but is not limited to, a leach solution and/or a pregnant leach solution (“PLS”).

The term “refined acid extraction product” is defined herein as a product from acid extraction after pre-processing, including, but not limited to, the removal of acid; alteration of pH; removal of specific ions, including, but not limited to, at least some lithium; filtration; contact with a selective membrane; alteration of temperature; alteration of fluid flow, turbidity, viscosity, and/or flux; or a combination thereof.

The term “acid” or “acids” is defined herein as a solution with a pH below 7.

The term “extract” is defined herein as a process used to liberate, leach, free, or remove metal or metals from a material.

The term “DGA resin” is defined herein as N,N,N′,N′-tetra-n-octyldiglycolamine and/or any chemical variant of N,N,N′,N′-tetra-n-octyldiglycolamine.

The term “mineral” is defined herein as an inorganic element or compound having an orderly internal structure, and characteristic chemical composition, crystal form, and/or physical properties.

The terms “membrane” for “membranes” as used herein include, but are not limited to, a nanofiltration membrane, a reverse osmosis membrane, or a combination thereof.

The terms “carousel” or “carousel system” as used herein refer to a column system comprising a plurality of columns in communication with a multi-port valve. The plurality of columns operate by countercurrent ion exchange.

The term “countercurrent ion exchange” refers to a steady state process to separate ions from dilute solutions.

The term “pad” refers as used herein means an engineered structure for holding a mineral. The pad may be lined with an impermeable layer and/or may be configured to receive a mineral and a reagent, e.g., an acid, for contacting the mineral.

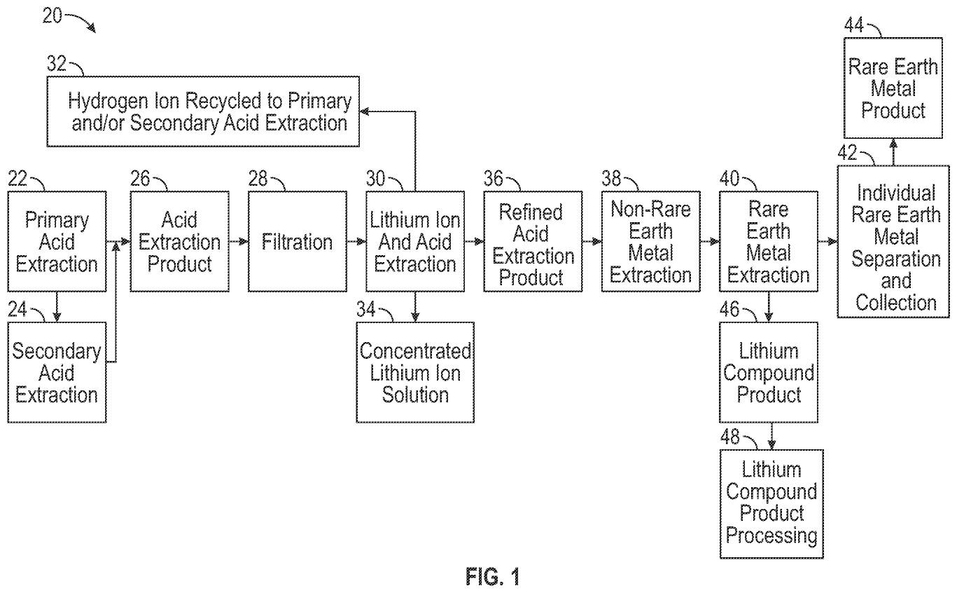

Turning now to the drawings, FIG. 1 shows a process flow diagram of metal extraction system 20. Material comprising REMs and/or lithium is contacted with acid to undergo primary acid extraction 22 to form acid extraction product 26. Optionally, the material undergoes secondary acid extraction 24 to improve the extraction of metal from the material including, but not limited to, lithium. Acid extraction product 26 undergoes lithium ion and acid extraction 30 to product concentrated lithium ion solution 34 and refined acid extraction product 36. Optionally, acid extraction product 26 undergoes filtration 28 before lithium ion and acid extraction 30. Hydrogen ions from lithium ion and acid extraction 30 may be recycled 32 to primary acid extraction 22 or secondary acid extraction 24. Refined acid extraction product 36 undergoes non-rare earth metal extraction 38 and rare earth metal extraction 40 to form lithium compound product 46 and a mixed REM product. Lithium compound product 36 undergoes lithium compound product processing 48 to form end product lithium compounds including, but not limited to, lithium carbonate and/or lithium hydroxide. The mixed REM product undergoes individual rare earth metal separation and collection 42 to form rare earth metal product 44 comprising a purified and/or concentrate individual rare earth product.

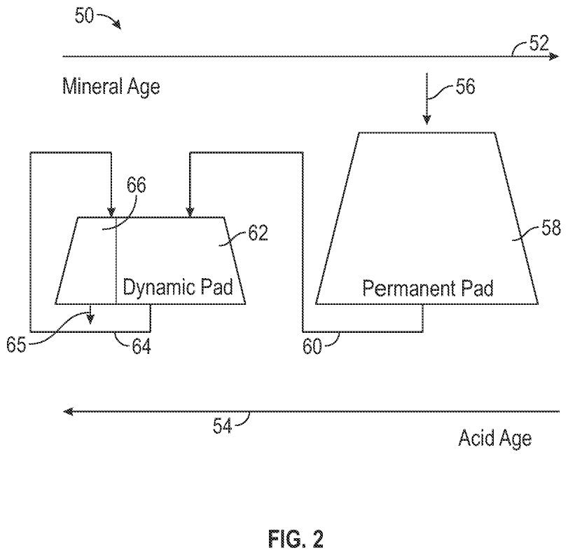

FIG. 2 shows metal extraction process 50 from a mineral. The age of the mineral increases along path 52, with the age of the mineral increasing from left to right according to path 52. For example, the left end of path 52 may represent mineral aged by about 0 days, while the right end of path 52 may represent mineral aged by about 500 days. The age of the acidic solution increases along path 54, with the age of the acidic solution increasing from right to left along path 54. For example, the right end of path 54 may represent acidic solution aged by about 0 days, while the left end of path 54 may present acidic solution aged by about 250 days.

Fresh acidic solution 56 enters permanent pad 58 and is contacted with aged mineral at least partially disposed within permanent pad 58. Fresh acidic solution 56 extracts lithium from aged mineral at least partially disposed within permanent pad 58 and into an acidic solution and enters a reclamation pond (not shown). Permanent pad acidic effluent 60 flows into second stage dynamic pad 62 and contacts mineral at least partially disposed within second stage dynamic pad 62. Permanent pad acidic effluent 60 extracts rare earth metal from mineral at least partially disposed within second stage dynamic pad 62. Second stage dynamic pad effluent 64 exits second stage dynamic pad 62 and flows into first stage dynamic pad 66. Second stage dynamic pad effluent 64 extracts rare earth metal from mineral at least partially disposed within first stage dynamic pad 66. First stage dynamic pad effluent 65 exits first stage dynamic pad 66. The concentration of rare earth metal in second stage dynamic pad effluent 64 is less than the concentration of rare earth metal in first stage dynamic pad effluent 65.

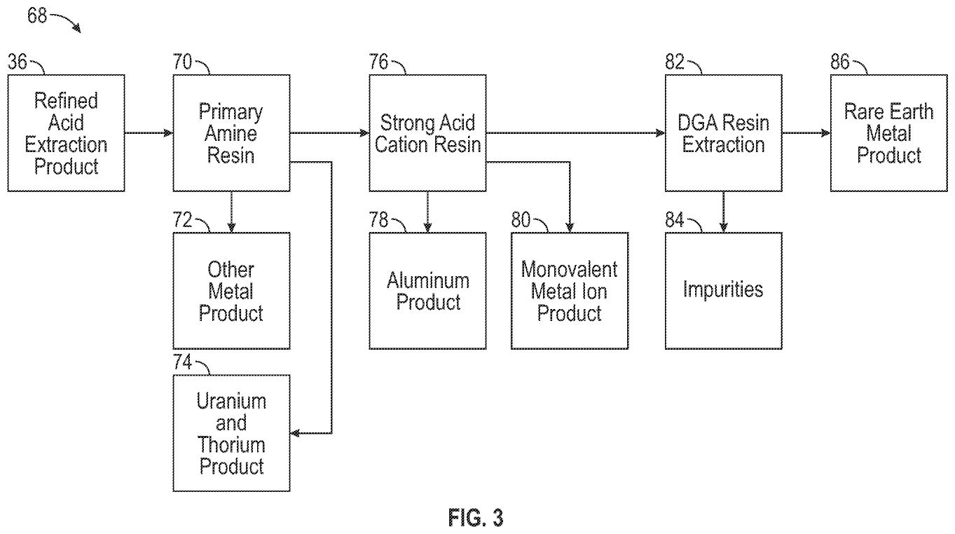

FIG. 3 shows process flow diagram 68 for a method of rare earth metal extraction. Refined acid extraction product 36 is contacted with primary amine resin 70 to produce other metal product 72, uranium and/or thorium product 74, and a first product stream comprising a rare earth metal. The product stream is contacted with a strong cation resin 76 to produce aluminum product 78, monovalent metal ion product 80, and a second product stream comprising a rare earth metal. The product stream is contacted with a DGA resin and undergoes DGA resin extraction 82 to separate impurities 84 and mixed rare earth metal product 86.

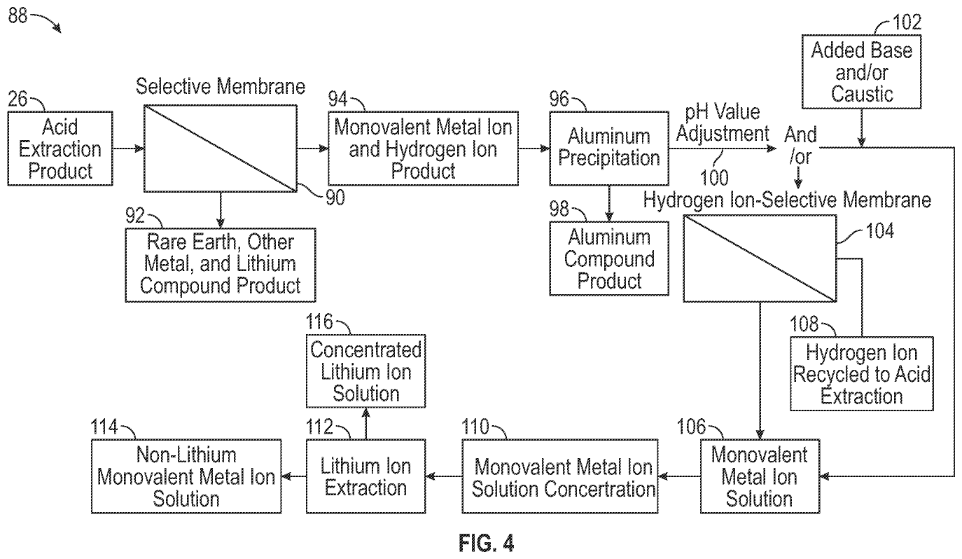

FIG. 4 shows process flow diagram 88 for a method lithium extraction. Acid extraction product 26 is contacted with selective membrane 90 to product rare earth, other metal, and lithium compound product 92; and monovalent metal ion and hydrogen ion product 94. Monovalent metal ion and hydrogen ion product 94 undergoes aluminum precipitation 96 to form aluminum product compound 98 and a lithium ion product stream. The lithium ion product stream undergoes pH value adjustment 100 through added base and/or caustic 102 and/or contact with hydrogen ion-selective membrane 104. Hydrogen ion is recycled 108 to the acid extraction if the lithium ion product stream is contacted with hydrogen ion-selective membrane 104. pH value adjustment 100 of the lithium ion product stream yields monovalent metal ion solution 106 that then undergoes monovalent metal ion solution concentration 110 to form a concentrated monovalent ion product stream. The concentrated monovalent ion product stream undergoes lithium ion extraction 112 by contact with a lithium-selective sorbent to form non-lithium monovalent metal ion solution 114 and concentrated lithium ion solution 116.

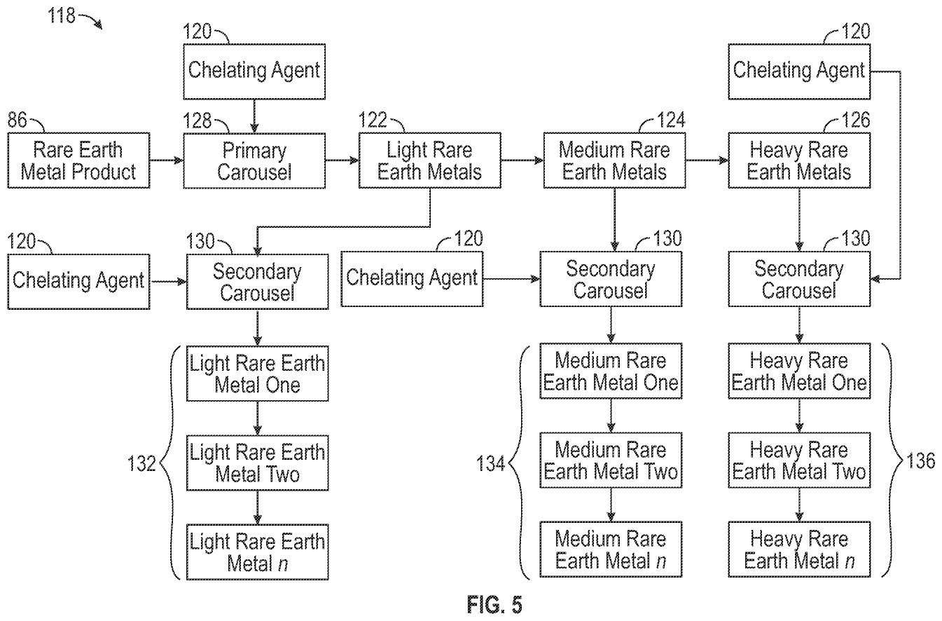

FIG. 5 shows process flow diagram 118 for a method of rare earth metal separation. Rare earth metal product 86 is contacted with primary carousel 128 and chelating agent 120 to form light rare earth metals 122, medium rare earth metals 124, and heavy rare earth metals 126. Light rare earth metals 122, medium rare earth metals 124, and heavy rare earth metals 126 are contacted with secondary carousel 130 and chelating agent 120 to form plurality of light rare earth metals 132, plurality of medium rare earth metals 134, and plurality of heavy rare earth metals 136, respectively.

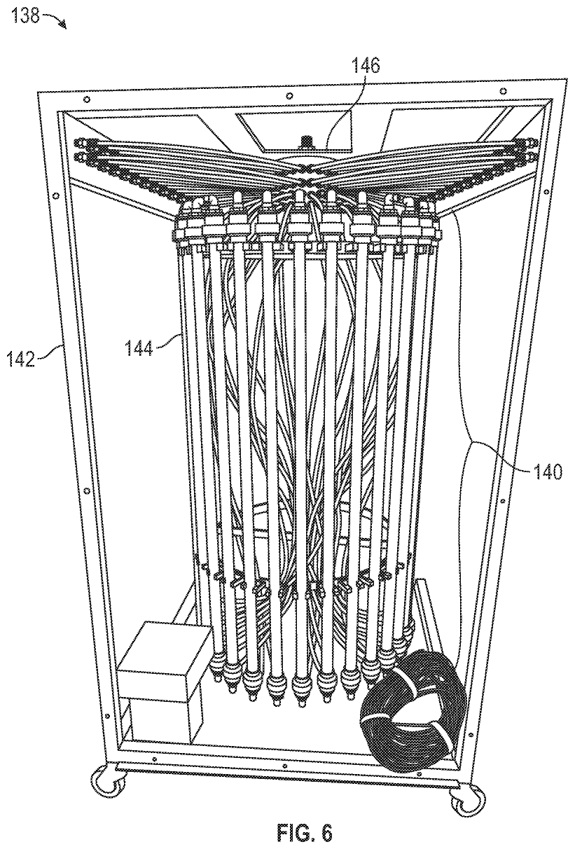

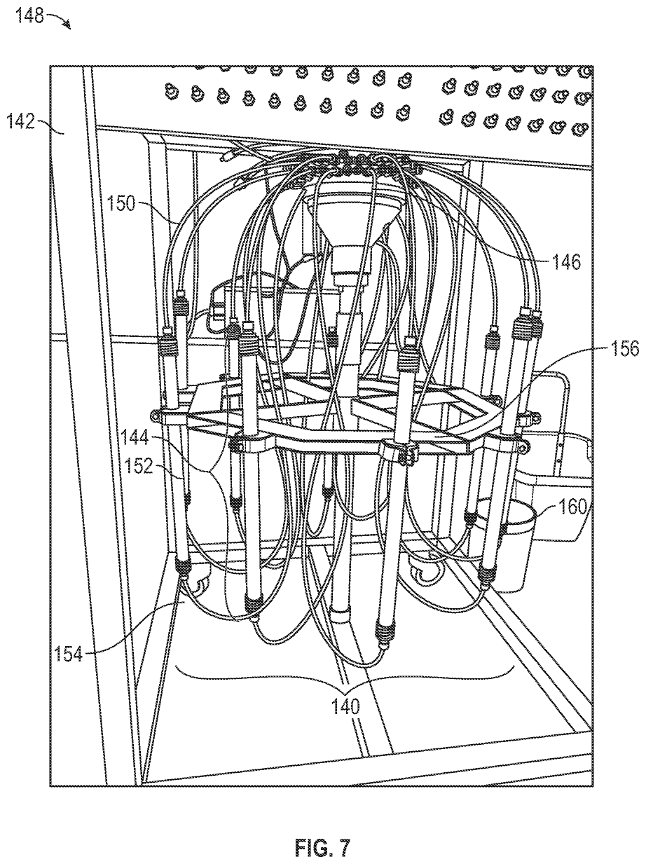

FIGS. 6 and 7 show exemplary embodiments of carousel systems. FIG. 6 shows carousel system 138 comprising column array 140 disposed within carousel cage 142 comprising column 144, and in communication with multi-port valve 146. FIG. 7 shows carousel system 148 also comprising column array 140 disposed within carousel cage 142 comprising column 144, and in communication with multi-port valve 146. Conduit 150 feeds metal-containing solution from multi-port valve 146 into column 144 to allow contact with resin 152 to extract a selected metal. Conduit 154 allows the remaining solution to pass out of column 144. Waste is collected in vessel 160.

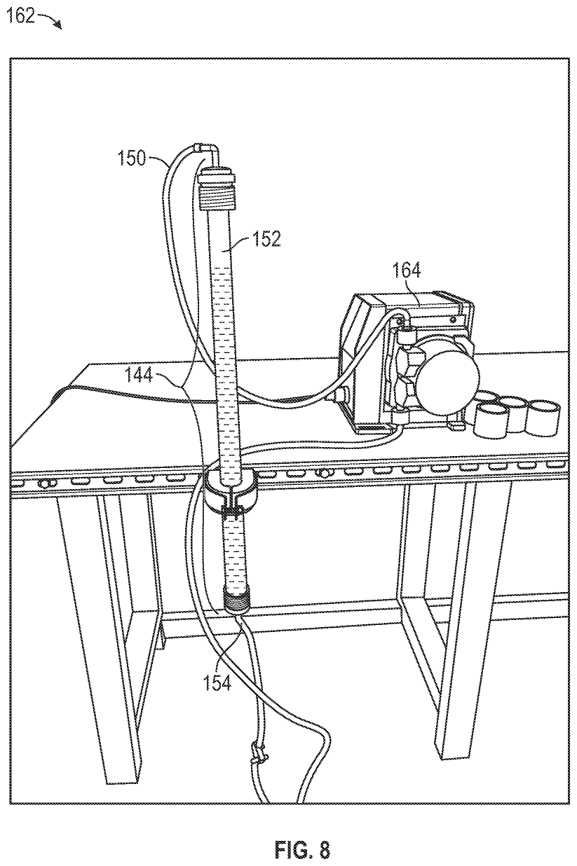

FIG. 8 shows an exemplary embodiment of a column system. FIG. 8 shows column system 162 comprising pump 164, conduit 150, column 144, resin 152, and conduit 154. Pump 164 flows metal-containing solution into conduit 150 which feeds metal-containing solution into column 144 to allow contact with resin 152 to extract a selected metal. Conduit 154 allows the remaining solution to pass out of column 144.

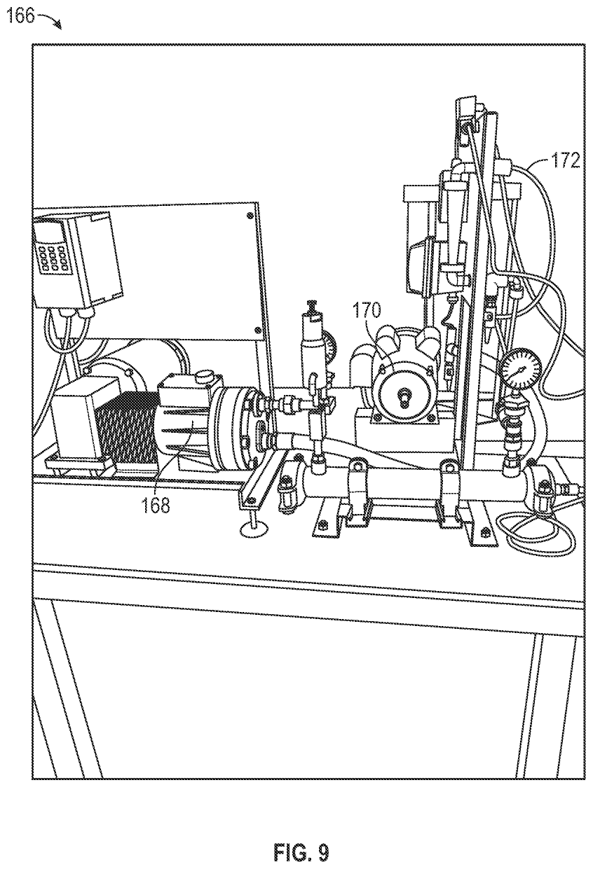

FIG. 9 shows membrane system 166 comprising pump 168, membrane 170, and conduit 172. Pump 168 feeds metal-containing solution into membrane 170 to remove impurities including, but not limited to, multi-valent metal ions, particles, or a combination thereof. The filtered solution passes out of membrane system 166 via conduit 172.

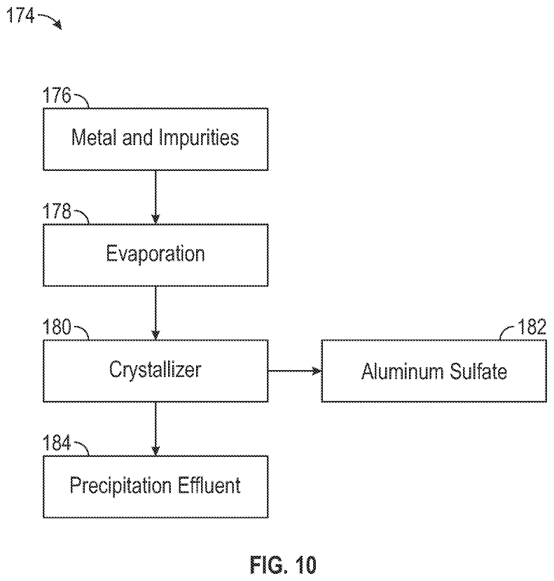

FIG. 10 shows an aluminum precipitation reaction 174. Aluminum compounds are formed and precipitated during precipitation reaction 174. A pregnant solution 176 comprising metal and impurities undergoes evaporation 178 followed by crystallization reaction 180 to form aluminum sulfate 182 and precipitation reaction effluent 184. The crystallization reaction may occur between 2° C. and 10° C. Precipitation reaction effluent 184 comprises lithium and is removed from aluminum sulfate 182 as shown in FIG. 4.

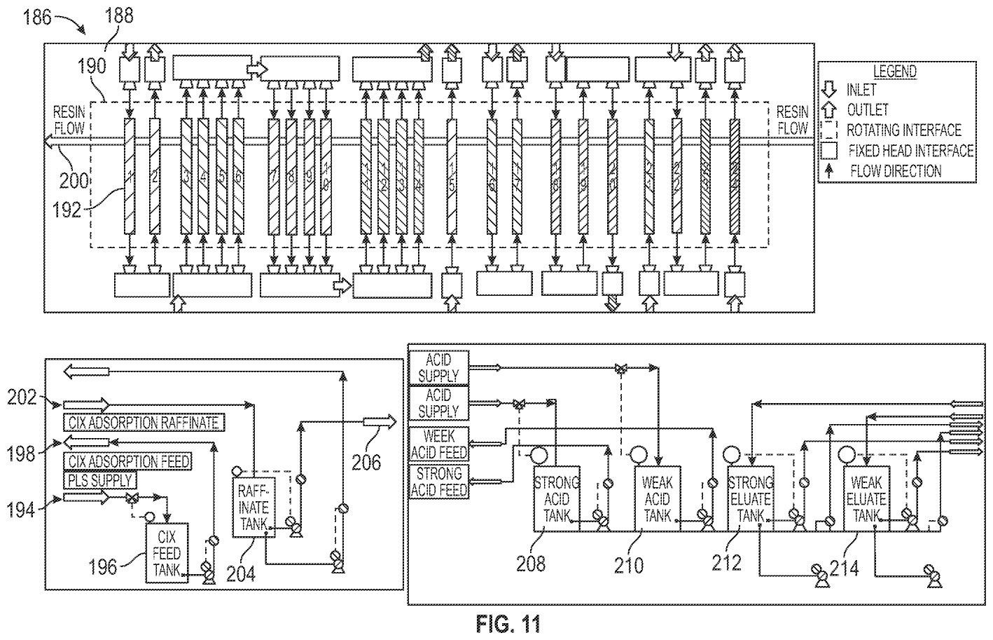

Extraction systems 186, 216, 236, and 260 are shown separately in FIGS. 11, 12, 13, and 14, respectively. FIG. 11 shows extraction system 186 comprising fixed head interface 188, rotating interface 190, column array 192, and resin flow 200. Fixed head interface 188 may comprise carousel cage 142, as shown in FIGS. 6 to 7. Rotating interface 190 may comprise carousel system 138, as shown in FIGS. 6 to 7. Column array 192 may comprise column array 140, as shown in FIGS. 6 to 7. Metal-containing solution 194 (e.g., pregnant leach solution supply), enters countercurrent ion-exchange feed tank 196. Countercurrent adsorption feed 198 is pumped out of countercurrent ion-exchange feed tank 196 into column array 192 and passes through columns 1 to 24. Metal is selectively adsorbed onto resins at least partially disposed within columns 1 to 24. Countercurrent ion-exchange adsorption raffinate 202 enters raffinate tank 204. Feed 206 is pumped out of raffinate tank 204. Strong acid tank 208 and weak acid tank 210 provide acid to extraction system 186. Strong eluate tank 212 and weak eluate tank 214 receive acidic eluate from extraction stage 186. Extraction systems 236 and 260 also comprise acid tanks for supplying acidic solution.

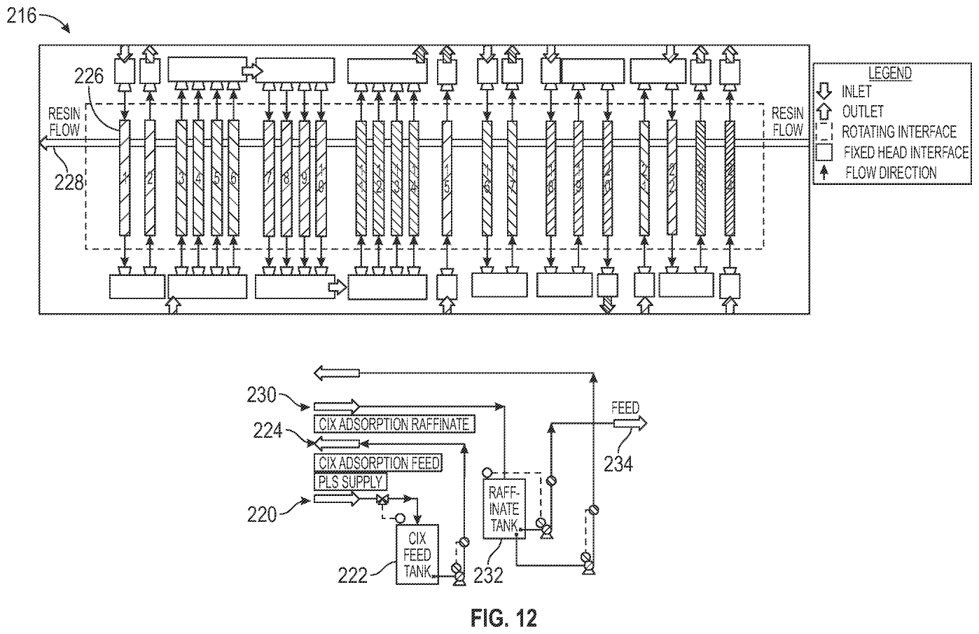

FIG. 12 shows extraction system 216 comprising column array 226, and resin flow 228. Countercurrent ion-exchange supply 220 enters countercurrent ion-exchange feed tank 222. Countercurrent adsorption feed 224 is pumped out of countercurrent ion-exchange feed tank 222 into column array 226 and passes through columns 1 to 24. Metal is selectively adsorbed onto resins at least partially disposed with columns 1 to 24. Countercurrent ion-exchange adsorption raffinate 230 enters raffinate tank 232. Feed 234 is pumped out of raffinate tank 232.

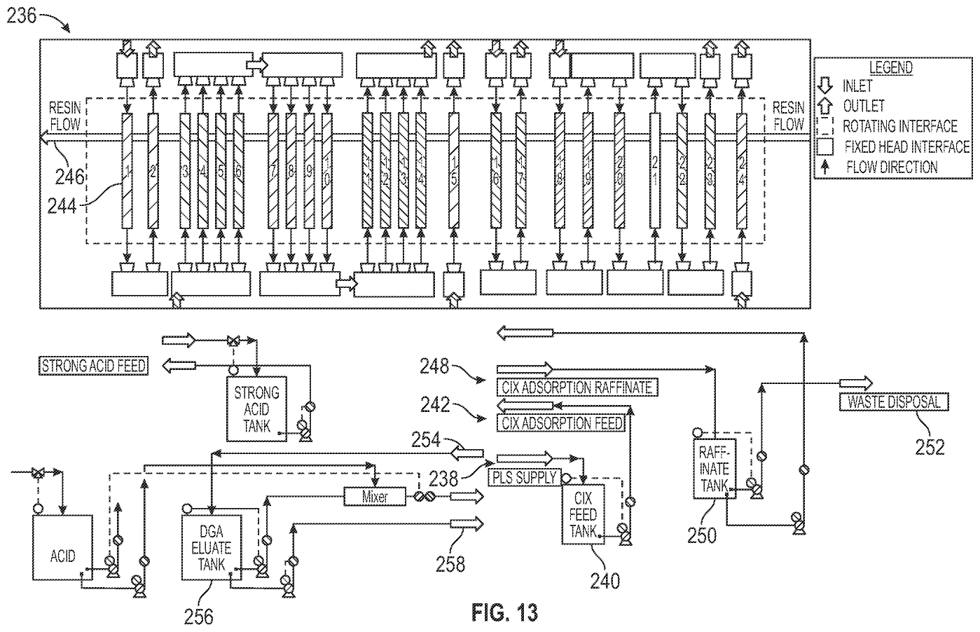

FIG. 13 shows extraction system 236 comprising column array 244, and resin flow 246. Countercurrent ion-exchange supply 238 enters countercurrent ion-exchange feed tank 240. Countercurrent adsorption feed 242 is pumped out of countercurrent ion-exchange feed tank 240 into column array 244 and passes through columns 1 to 24. Metal is selectively adsorbed onto resins at least partially disposed with columns 1 to 24. Countercurrent ion-exchange adsorption raffinate 248 enters raffinate tank 250. Waste 252 is pumped out of raffinate tank 250. Metal eluate 254 enters metal (e.g., rare earth element) eluate tank 256 from the column arrays and feed 258 containing concentrated metal and/or metal ions is pumped out of eluate tank 256.

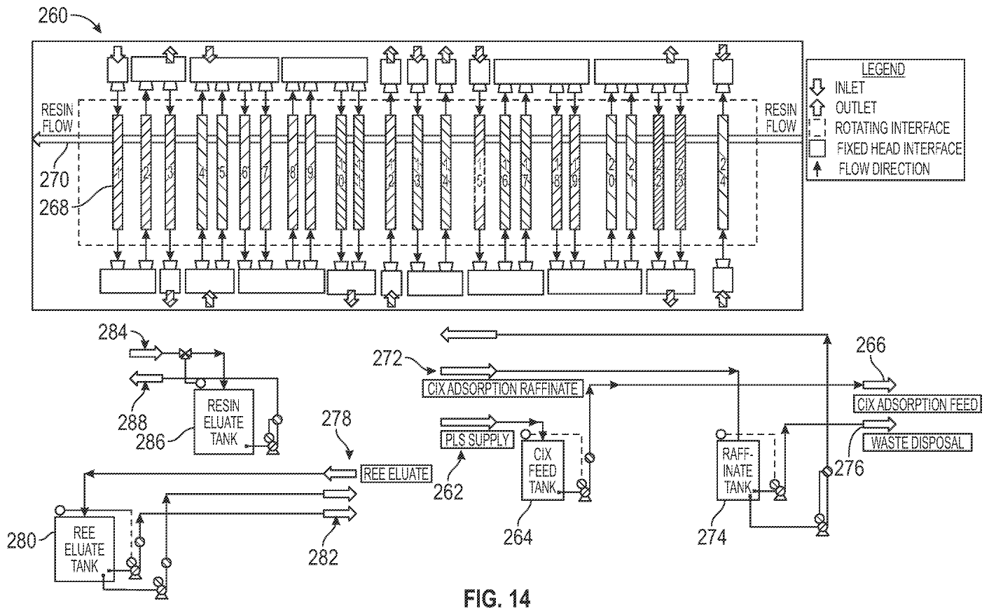

FIG. 14 shows extraction system 260 comprising column array 268, and resin flow 270. Countercurrent ion-exchange supply 262 enters countercurrent ion-exchange feed tank 264. Countercurrent adsorption feed 266 is pumped out of countercurrent ion-exchange feed tank 264 into column array 268 and passes through columns 1 to 24. Metal is selectively adsorbed onto resins at least partially disposed with columns 1 to 24. Column array 268 may comprise DGA resin. Countercurrent ion-exchange adsorption raffinate 272 enters raffinate tank 274. Waste 276 is pumped out of raffinate tank 274. Metal eluate 278 enters metal (e.g., rare earth element) eluate tank 280 from the column arrays and feed to refinery 282 containing concentrated metal and/or metal ions is pumped out of eluate tank 280. DGA eluent 284 enters DGA resin eluent tank 286 and DGA eluent 288 is pumped out of DGA resin eluent tank 286.

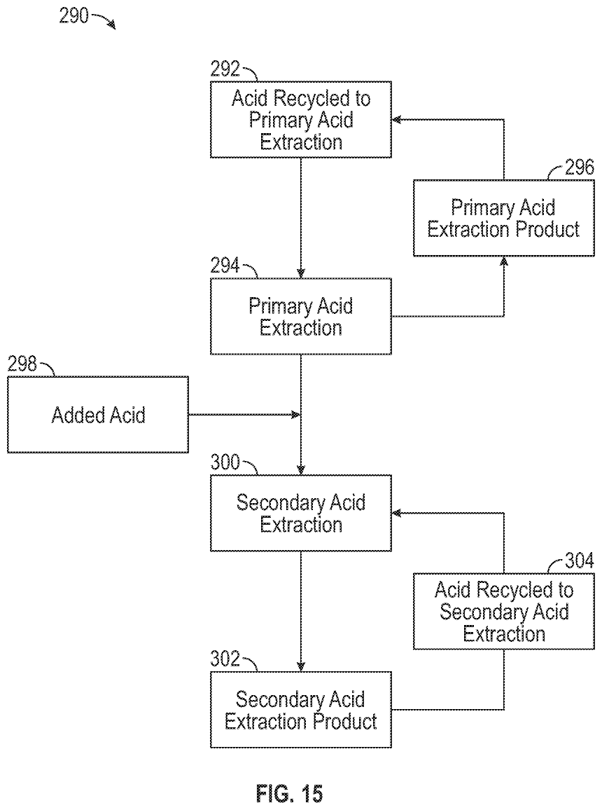

FIG. 15 shows process flow diagram 290 for a method of two-stage lithium extraction from a mineral. Material comprising lithium and/or a lithium compound undergoes primary acid extraction 294 to form primary acid extraction product 296. Remaining acid is recycled 292 to primary acid extraction 294. Added acid 298 is provided to the material comprising lithium and/or a lithium compound to achieve secondary acid extraction 300 and form secondary acid extraction product 302. Added acid 298 has greater acid concentration compared to the acid added during primary acid extraction 294. Remaining acid from secondary acid extraction product 302 is recycled 304 into secondary acid extraction 300.

The apparatus and method of the present invention may be used to extract a metal. The extracted metal may comprise at least one rare earth metal. The extracted metal may comprise neodymium (“Nd”), praseodymium (“Pr”), dysprosium (“Dy), copper (“Cu”), lithium (“Li”), sodium (“Na”), magnesium (“Mg”), potassium (“K”), calcium (“Ca”), titanium (“Ti”), vanadium (“V”), chromium (“Cr”), manganese (“Mn”), iron (“Fe”), cobalt (“Co”), nickel (“Ni”), cadmium (“Cd”), zinc (“Zn”), aluminum (“Al”), silicon (“Si”), silver (“Ag”), tin (“Sn”), platinum (“Pt”), gold (“Au”), bismuth (“Bi”), lanthanum (“La”), europium (“Eu”), gallium (“Ga”), scandium (“Sc”), strontium (“Sr”), yttrium (“Y”), zirconium (“Zr”), niobium (“Nb”), molybdenum (“Mo”), ruthenium (“Ru”), rhodium (“Rh”), palladium (“Pd”), indium (“In”), hafnium (“Hf”), tantalum (“Ta”), tungsten (“W”), rhenium (“Re”), osmium (“Os”), iridium (“Ir”), mercury (“Hg”), lead (“Pb”), polonium (“Po”), cerium (“Ce”), samarium (“Sm”), erbium (“Er”), ytterbium (“Yb”), thorium (“Th”), uranium (“U”), plutonium (“Pu”), terbium (“Tb”), promethium (“Pm”), tellurium (“Te”), or a combination thereof.

The apparatus and method of the present invention may be used to extract at least one light rare earth metal. Light rare earth metal comprises, but is not limited to, lanthanum (“La”), cerium (“Ce”), praseodymium (“Pr”), neodymium (“Nd”), promethium (“Pm”), samarium (“Sm”), scandium (“Sc”), or a combination thereof.

The apparatus and method of the present invention may be used to extract at least one medium rare earth metal. Medium rare earth metal comprises, but are not limited to, europium (“Eu”), gadolinium (“Gd”), or a combination thereof.

The apparatus and method of the present invention may be used to extract at least one heavy rare earth metal. Heavy rare earth metals comprise, but are not limited to, terbium (“Tb”), dysprosium (“Dy”), yttrium (“Y”), holmium (“Ho”), erbium (“Er”), thulium (“Tm”), ytterbium (“Yb”), lutetium (“Lu”), or a combination thereof.

The method and apparatus of the present invention relate to metal extraction to separate rare earth metal from an acid extraction product, including, but not limited to, a solution or mixture. An amine resin may be used to extract metal, including, but not limited to, Ur, Th, Be, Zr, Hf, or a combination thereof. The amine resin may be a primary amine resin. The primary amine resin may comprise, but is not limited to, styrene divinylbenzene tertiary; a quaternary amine group; a type one strong base anion resin; a type two strong base anion resin; a weak base anion resin; or a combination thereof. The extraction efficiency of the primary amine resin may be at least about 80%, about 80% to about 98%, about 85% to about 95%, or about 90%. The flow rate through the resin may be at least about 2 BV/h, about 2 BV/h to about 30 BV/h, about 5 BV/h to about 25 BV/h, about 10 BV/h to about 20 BV/h, or about 30 BV/h. The primary amine resin may comprise a cross linkage of at least about 1%, about 1% to about 20%, about 2% to about 18%, about 4% to about 16%, about 6% to about 14%, about 8% to about 12%, or about 20%. The primary amine resin may be washed with a solution, including, but not limited to, water, diluted acid, or a combination thereof. The primary amine resin may be eluted with a solution, including, but not limited to, an acid, ethanol, water, an aqueous solution of metal and/or metal ions, acetone, methanol, or a combination thereof.

A N,N,N′,N′-tetra-n-octyldiglycolamine (“DGA”) resin may be used to extract rare earth metal and remove and/or separate impurities from a refined acid extraction product. The extraction efficiency of the DGA resin may be at least about 80%, about 80% to about 98%, about 85% to about 95%, or about 90%. The DGA resin may comprise, but is not limited to, a styrene divinylbenzene tertiary; quaternary amine groups; bis(2-ethylhexyle) phosphate (“D2HEPA”); trioctyl phosphine oxide (“TOPO”); 2-ethylhexylphophonic acid mono-2-ethylhexyl ester (“HEHEHP (PC88A)”) or a combination thereof. The resin may be contacted with a solvating extracting including, but not limited to, dialkyl phosphinic acid, Cyanex 272; neodecanoic acid; naphthenic acid; tributyl phosphate; tricaprylylmethylammonium chloride; 2-ethylhexyl phosphonic acid mono-2-ethylhexyl ester; phosphonic acid; or a combination thereof. The flow rate through the resin may be at least about 2 BV/h, about 2 BV/h to about BV/h, about 5 BV/h to about 25 BV/h, about 10 BV/h to about 20 BV/h, or about 30 BV/h. The DGA resin may comprise a DGA concentration on its surface of at least about 5%, about 5% to about 50%, about 10% to about 45%, about 15% to about 40%, about 20% to about 35%, or about 50%. The DGA resin may be washed with a solution, including, but not limited to, water, diluted acid, or a combination thereof. The DGA resin may be eluted with a solution, including, but not limited to, an acid.

The method and apparatus of the present invention relate to metal extraction to separate rare earth metals into light, medium, and heavy rare earth metals, and to separate light, medium, and heavy rare earth metals into individual light, medium, and heavy rare earth metals. Rare earth metal product may be contacted with a primary carousel comprising resin at least partially disposed within a column.

The rare earth product may be contacted with a chelating agent while passing through the column. The chelating agent may include, but is not limited to, glycolic acid, lactic acid, citric acid, nitrilotriacetate (“NTA”), 2,2′-bis-[2-di(carboxymethyl)-aminoethoxy] ethane (“DE”), 2,2′-bis-[di(carboxymethyl)-amino] diethyl ether (“ME”), N¹-(hydroxyethyl) ethylenediamine-N,N,N′-triacetic acid (“HEDTA”), ethylenediaminetetraacetic acid (“EDTA”), 1,2,-daiminocyclohexane-N,N,N¹,N¹-tetracetic acid (“DCTA”), carboxymethyl-bis-[2-di(carboxymethyl)-aminoethyl] amine (“DTPA”), triaminotriethylamine, aminopolyacetic acid, aminopolycarboxylic acid, or a combination thereof. The concentration of the chelating agent may be in the range of at least about 0.05 M, about 0.05 M to about 3 M, about 0.1 M to about 2.5 M, about 0.5 M to about 2.0 M, about 1 M to about 1.5 M, or about 3 M.

The chelating agent and column may separate the rare earth metal product into light, medium, and heavy rare earth metal. The chelating agent may be used to change the order of rare earth metal elution from the column based on the type of rare earth metal. For example, specific chelating agents may cause rare earth metals to be eluted in the following orders: (1) heavy, (2) medium, (3) light; (1) medium, (2) light, (3) heavy; (1) light, (2) medium, (3) heavy; (1) heavy, (2) light, (3) medium; (1) medium, (2) heavy, (3) light; and (1) light, (2) heavy, (3) medium. The numbers (1), (2), and (3) indicate the order of elution from the column, with number (1) being eluted first. A single column may be used to separate light, medium, or heavy rare earth metals, with each column containing a single type of rare earth metal. For example, a first column may be used to separate and contain light rare earth metals, a second column may be used to separate and contain medium rare earth metals, and a third column may be used to separate and contain heavy rare earth metals. Light, medium, and/or heavy rare earth metals may be contacted with a secondary carousel comprising resin at least partially disposed within a column and a chelating agent. The secondary carousel and chelating agent may be used to separate and contain an individual rare earth metal. A single column may be used to separate an individual rare earth metal, with each column containing single rare earth metal. For example, medium rare earth metals may be separated using two columns, with a first column used to separate and contain Eu, and a second column used to separate and contain Gd.

The flow rate through the column resin may be at least about 2 BV/h, about 2 BV/h to about 30 BV/h, about 5 BV/h to about 25 BV/h, about 10 BV/h to about 20 BV/h, or about 30 BV/h. The column resin may be washed with a solution, including, but not limited to, water, diluted acid, or a combination thereof. The column resin may be eluted with a solution, including, but not limited to, an acid. Optionally, the primary and/or secondary carousel may be replaced with a fixed bed, a simulated moving bed, or a combination thereof. The column resin may be regenerated by acidic media, including, but not limited to, sulfuric acid; hydrochloric acid; nitric acid; or a combination thereof. The column resin may also be regenerated by water or an aqueous solution.

The method and apparatus may comprise a membrane. The acidic solution may comprise sulfuric acid; hydrochloric acid; nitric acid; other strong acid; or a combination thereof. The membrane may achieve dewatering and/or concentration of an acidic solution. The solute and/or ion concentration of the acidic solution before dewatering and/or concentrating may be at least about 750 ppm, about 750 ppm to about 1100 ppm, about 800 ppm to about 1000, about 850 ppm to about 950, or about 1100 ppm. The solute and/or ion concentration of the acidic solution after dewatering and/or concentrating may be at least about 3500 ppm, about 3500 ppm to about 6500 ppm, about 4000 ppm to about 6000 ppm, about 4500 ppm to about 5500 ppm, or about 6500 ppm. The membrane may concentrate an acidic solution by at least about 35%, about 35% to about 65%, about 40% to about 60%, about 45% to about 55%, or about 65%. The input flow rate to the membrane may be at least about 850 meters cubed/hour (“m³/hr”), about 850 m³/hr to about 550 m³/hr, about 825 m³/hr to about 575 m³/hr, about 800 m³/hr to about 600 m³/hr, about 775 m³/hr to about 625 m³/hr, about 750 m³/hr to about 650 m³/hr, about 725 m³/hr to about 675 m³/hr, about 850 m³/hr. The output flow rate to the membrane may be at least 250 m³/hr, about 250 m³/hr to about 450 m³/hr, about 275 m³/hr to about 425 m³/hr, about 300 m³/hr to about 400 m³/hr, about 325 m³/hr to about 375 m³/hr, about 450 m³/hr.

The membrane may separate multivalent ions from monovalent or divalent ions. The membrane may separate Hf, Ga, Li, Mg, ferrous ion, multivalent Al, or a combination thereof from monovalent or divalent ions.

The method and apparatus may comprise an anti-scaling reagent. The anti-scaling reagent may comprise sodium hexametaphosphate; bismuth phosphate; magnesium; other phosphate salt; other magnesium salt; or a combination thereof. The anti-scaling reagent may be contacted with the acidic solution, feed, eluent, or any other solution in the method or apparatus at any point in the method or apparatus.

The method and apparatus of the present invention relate to lithium extraction to separate lithium ions from an acid extraction product including, but not limited to, a solution or mixture. The acid extraction product may be contacted with a first membrane. The first membrane may be selective for Li ions and/or monovalent ions. The monovalent ions may include, but are not limited to, hydrogen (“H”), aluminum (“Al”), potassium (“K”), sodium (“Na”), or a combination thereof.

At least about 70%, about 70% to about 99%, about 75% to about 97%, about 80% to about 95%, about 85% to about 90%, of Li ions may be removed by the first membrane. The first membrane may operate under acidic conditions. The acidic conditions may comprise contact with a solution comprising a pH of at least about 0, about 0 to about 3, about 0.5 to about 2, about 1 to about 1.5, or about 3. Acid extraction product contact with the first membrane may form an acidic ionic solution. The concentration of Li ion may be at least about 80 ppm, about 80 ppm to about 200 ppm, about 90 ppm to about 175 ppm, about 100 ppm to about 150 ppm, or about 200 ppm.

Al may be precipitated from the acidic ionic solution as an Al compound, including, but not limited to, aluminum sulfate. Other monovalent ions, including Fe, Zn, and Cu ions, may be precipitated from the acidic ionic solution.

The aluminum may be precipitated by concentrating a pregnant solution. The pregnant solution may be free of rare earth metals, thorium, and uranium. The pregnant solution may be concentrated to at least about 35 grams/liter (“g/L”), about 35 g/L to about 65 g/L, about 40 g/L to about 60 g/L, about 45 g/L to about 55 g/L, or about 65 g/L Al. The concentration may be achieved by evaporation. The temperature of the concentrated solution may be decreased from ambient temperature to precipitate Al. The temperate at which the Al precipitates may be at least about 2° C., about 2° C. to about 10° C., about 2.5° C. to about 7.5° C., about 3° C. to about 7° C., about 3.5° C. to about 6.5° C., about 4° C. to about 6° C., about 4.5° C. to about 5.5° C., or about 8° C.

The precipitated aluminum may comprise aluminum sulfate tetra decahydrate, which may comprise the formula Al₂(SO₄)₃·14H₂O. The number of waters of crystallization in Al₂(SO₄)₃·14H₂O may be at least about 13.9, about 13.9 to about 14.5, about 14 to about 14.4, about 14.1 to about 14.3, or about 14.5 H₂O.

The pH of the acidic ionic solution may be increased. The pH may be increased by contacting the acidic ionic solution with a caustic and/or base. The pH may be increased by contacting the acidic ionic solution with a second membrane. The second membrane may be selective for hydrogen ion/proton. The hydrogen ion/proton may be recycled into a material to be extracted. Optionally, the acid extraction product and/or acidic ionic solution may be concentrated by reverse osmosis.

The first and/or second membrane may function at a pressure flow rate of at least about 700 psi, about 700 psi to about 1800 psi, about 800 psi to about 1600 psi, about 1000 psi to about 1400 psi, or about 1800 psi. The first and/or second membrane may function at a flow rate of at least about 5 gallons per minute (“GPM”), about 5 GPM to about 500 GPM, about 50 GPM to about 450 GPM, about 100 GPM to about 400 GPM, about 150 GPM to about 350 GPM, about 200 GPM to about 300 GPM, or about 500 GPM.

The acidic ionic solution may be contacted with a resin to extract lithium, lithium chloride, lithium sulfate, lithium hydroxide, sodium, potassium, or a combination thereof. The resin may extract lithium ions from a solution with pH values of at least about 4, about 4 to about 9, about 4.5 to about 8, about 5 to about 7, or about 9.

Optionally, a third membrane may be used in place of the first membrane to remove only hydrogen, other monovalent, divalent, magnesium, or a combination thereof. Contacting the acid extraction product with the third membrane may produce a solution comprising at least about 400 ppm, about 400 ppm to about 600 ppm, about 450 ppm to about 550 ppm, or about 500 ppm Li ions.

The method and apparatus may comprise leaching rare earth metal and/or lithium from a mineral and may comprise a permanent pad and a dynamic pad. The dynamic pad may comprise a first cavity and a second cavity. The dynamic pad may also comprise a reclaimer section and/or a damn to direct fluid flow. Mineral may be disposed within the dynamic pad. The rare earth mineral may comprise rare earth metal and/or lithium. Rare earth metal may be extracted from the mineral by contacting the mineral with an acid. Rare earth mineral may be extracted from the first cavity over a period of at least about 1, about 1 to about 30, about 5 to about 25, about 10 to about 20, or about 30 days. Rare earth mineral may be extracted from the second cavity over a period of at least about 1, about 1 to about 90, about 5 to about 85, about 10 to about 80, about 15 to about 75, about 20 to about 70, about 25 to about 65, about 30 to about 60, about 35 to about 55, about 40 to about 50, or about 90 days. The rare earth metal may be extracted from the mineral by contacting the mineral with an acidic solution. The dynamic pad may be partitioned in any length ratio along a length of the dynamic pad to form the first cavity and second cavity. For example, the ratio of the length of the first cavity to the length of the second cavity may be at least about 1:50, about 1:50 to about 50:1, about 1:40 to about 40:1, about 1:30 to about 30:1, about 1:20 to about 20:1, about 1:10 to about 10:1; about 2:1 to about 1:2, about 1:1, or any other ratio.

The permanent pad may be larger in diameter than the dynamic pad. The permanent pad may comprise a single cavity. Mineral may be disposed within the dynamic pad. The rare earth mineral may comprise rare earth metal and/or lithium. Lithium may be extracted from the mineral by contacting the mineral with an acid. Lithium may be extracted from the second cavity over a period of at least about 1, about 1 to about 120, about 10 to about 110, about 20 about 100, about 30 to about 90, about 40 to about 80, about 50 to about 60, or about 120 days. Effluent comprising lithium may exit the permanent pad.

The dynamic pad may be in communication with the permanent pad. The communication may be via a reclamation pond. The dynamic pad and/or permanent pad may be in communication with a reclamation pond. The reclamation pond may comprise rare earth metal and/or lithium.

Mineral may be first disposed into the first cavity of the dynamic pad. The mineral may be transferred to the second cavity of the dynamic pad. The mineral may then be transferred to the permanent pad. Rare earth metal and/or lithium may be extracted from mineral disposed in the dynamic pad and permanent pad. More rare earth metal may be extracted from the mineral disposed in first cavity of the dynamic pad than from the second cavity of the dynamic pad. More rare earth metal may be extracted from the dynamic pad than from the permanent pad. More lithium may be extracted from the permanent pad than from the dynamic pad.

Acid may be flowed from the permanent pad to the reclamation pond and/or the dynamic pad. The concentration of acid entering the dynamic pad may be at least about 35 g/L, about 35 g/L to about 55 g/L, about 40 g/L to about 50 g/L, or about 55 g/L. The concentration of the acid exiting the permanent pad and/or entering the second cavity of the dynamic pad may be least about 20 g/L, about 20 g/L to about 40 g/L, about 25 g/L to about 35 g/L, or about 55 g/L. The acid may exit the second cavity of the dynamic pad and enter the first compartment of the dynamic pad. The concentration of the acid exiting the second cavity of the dynamic pad and/or entering the first cavity of the dynamic pad may be least about 5 g/L, about 5 g/L to about 30 g/L, about 10 g/L to about 15 g/L, or about 30 g/L. The acid may exit the first cavity of the dynamic pad. The concentration of the acid exiting the first cavity of the dynamic pad may be at least about 0.25 g/L, about 0.25 g/L to about 25 g/L, about 1 g/L to about 20 g/L, about 2 g/L to about 18 g/L, about 4 g/L to about 16 g/L, about 6 g/L to about 14 g/L, about 8 g/L to about 12 g/L, or about 25 g/L.

Effluent comprising rare earth metal may exit the dynamic pad. The pH of the effluent may be at least about 0.1, about 0.1 to about 3, about 0.2 to about 2.5, about 0.3 to about 2, about 0.4 to about 1.5, about 0.5 to about 1, or about 3.

The method and apparatus may comprise a two-stage lithium extraction from a mineral. The mineral may be contacted with an acid in a two-stage method. The mineral may be in a heap, vat, column, or a combination thereof. The mineral may be leached by contacting the mineral with the acid. The leach may include, but is not limited to, a heap, vat, column, or percolation leach, or a combination thereof. The mineral may be agitated, agglomerated, roasted, baked, screened from fines, acid cured, or a combination thereof, before, during, and/or after the first and/or second stage of the two-stage method.

The acid used in the method may include, but is not limited to, sulfuric acid; hydrochloric acid; hydrofluoric acid; nitric acid; phosphoric acid; hydrobromic acid; hydroiodic acid; perchloric acid; hydrogen cyanide; sulfurous acid; nitrous acid; formic acid; oxalic acid; acetic acid; carbonic acid; or a combination thereof.

The mineral may be contacted with a surfactant, catalyst, carbonaceous matter, ammonium sulfate, or a combination thereof before, during, and/or after the first and/or second stage of the two-stage method. The surfactants may include, but are not limited to ionic, non-ionic, anionic, cationic, or zwitterionic surfactants, or a combination thereof. The carbonaceous matter may include, but is not limited to carbon black, graphite, charcoal, biochar, carbon nanotubes, or a combination thereof. The mineral may be bioleached before, during, and/or after the first and/or second stage of the two-stage method. The bioleach may comprise contacting the mineral with a bacterium.

The method may comprise lithium extraction from a material, the method comprising: contacting a material comprising lithium with a first acidic solution to produce a first product comprising lithium and/or a lithium ion; contacting the material with a second acidic solution, wherein the second acidic solution is more acidic than the first acidic solution, to produce a second product comprising lithium and/or lithium ion. The material may comprise an ore, ore concentrate, ore aggregate, an agglomerate, a slurry, or a combination thereof.

The mineral may comprise a typical size range of at least about 0.2 inches, about 0.2 inches to about 2 inches, about 0.5 inches to about 1.5 inches, or about 2 inches in diameter. The mineral may comprise a size range that is run of mine in size. The mineral may comprise fines and the fines may be agitated. Optionally, hydrofluoric acid may be generated at the extraction.

The extraction may comprise an initial leach of at least about 3 days, about 3 days to about 150 days, about 10 days to about 120 days, about 30 days to about 100 days, about 50 days to about 80 days, or about 150 days.

The concentration of acid in contact with the mineral and/or at least partially disposed within a mineral heap, may be at least about 10 g/L of acid, about 10 g/L to about 100 g/L, about 20 g/L to about 90 g/L, about 30 g/L to about 80 g/L, about 40 g/L to about 70 g/L, about 50 g/L to about 60 g/L, or about 100 g/L. The concentration of acid in leaving a mineral heap, may be at least about 1 g/L of acid, about 1 g/L to about 30 g/L, about 5 g/L to about 25 g/L, about 10 g/L to about 20 g/L, or about 30 g/L. Contacting the mineral with the acid may result in the formation of a pregnant leach solution (“PLS”). The PLS may comprise a pH of less than 0, about 0 to about 3, about 0.1 to about 2, about 0.2 to about 1.5, about 0.5 to about 1.0, or about 1.0.

The extraction may result in a rare earth extraction percentage of at least about 10%, about 10% to about 90%, about 20% to about 80%, about 30% to about 70%, about 40% to about 60%, or about 90% within 30 days. The extraction may result in a rare earth extraction percentage of about 50% to about 99%, about 60% to about 97%, about 70% to about 95%, about 80% to about 90%, or about 99% within 150 days. The extraction may result in a lithium extraction percentage of about 10% to about 80%, about 20% to about 70%, about 30% to about 60%, about 40% to about 50%, or about 80% within 30 days. The extraction may result in a lithium extraction percentage of about 50% to about 99%, about 60% to about 97%, about 70% to about 95%, about 80% to about 90%, or about 99% within 150 days.

The extraction may comprise an initial leach of at least about 30 days, about 30 days to about 500 days, about 50 days to about 450 days, about 75 days to about 400 days, about 100 days to about 300 days, about 150 days to about 250 days, about 175 days to about 225 days, or about 500 days.

The concentration of acid in contact with the mineral and/or at least partially disposed within a mineral heap, may be at least about 10 g/L of acid, about 10 g/L to about 200 g/L, about 20 g/L to about 180 g/L, about 40 g/L to about 160 g/L, about 60 g/L to about 140 g/L, about 80 g/L to about 120 g/L, or about 200 g/L. The concentration of acid in leaving a mineral heap, may be at least about 5 g/L of acid, about 5 g/L to about 175 g/L, about 10 g/L to about 150 g/L, about 50 g/L to about 125 g/L, about 75 g/L to about 100 g/L, or about 175 g/L. Contacting the mineral with the acid may result in the formation of a pregnant leach solution (“PLS”). The PLS may comprise a pH more negative than the pH of the PLS from the extraction, about 0 to about 3, about 0.1 to about 2, about 0.2 to about 1.5, about 0.5 to about 1.0, or about 1.0.

The extraction may result in a rare earth extraction percentage of about 10% to about 80%, about 20% to about 70%, about 30% to about 60%, about 40% to about 50%, or about 80% within 30 days. The extraction may result in a rare earth extraction percentage of about 50% to about 99%, about 60% to about 97%, about 70% to about 95%, about 80% to about 90%, or about 99% within 150 days. The extraction may result in a lithium extraction percentage of about 10% to about 80%, about 20% to about 70%, about 30% to about 60%, about 40% to about 50%, or about 80% within 30 days. The extraction may result in a lithium extraction percentage of about 50% to about 99%, about 60% to about 97%, about 70% to about 95%, about 80% to about 90%, or about 99% within 150 days.

The method and apparatus of the present invention relate to a method for Al precipitation for Li extraction under acidic conditions. An acidic solution comprising Li and Al ions may undergo evaporation to generate a more concentrated solution. The temperature for evaporation may be at least about 80° C., about 80° C. to about 90° C., about 82° C. to about 88° C., about 84° C. to about 86° C., or about 90° C. The temperature of the acidic solution comprising Li and Al ions may be decreased to at least about 3° C., about 3° C. to about 10° C., about 4° C. to about 8° C., about 5° C. to about 6° C., or about 10° C. to crystallize the aluminum into an aluminum compound. The aluminum compound may comprise aluminum sulfate, aluminum chloride, or a combination thereof. The aluminum compound precipitates out of solution at any efficiency of at least about 75%, about 75% to about 99%, about 80% to about 97%, about 85% to about 95%, or about 99%.

The method and apparatus of the present invention relate to a method for manufacturing a resin to extraction lithium ions under acidic conditions. The resin may extract lithium ions from a solution with a pH value of at least about 4, about 4 to about 9, about 4.5 to about 8, about 5 to about 7, or about 9. The flow rate through the resin may be at least about 2 BV/h, about 2 BV/h to about 30 BV/h, about 5 BV/h to about 25 BV/h, about 10 BV/h to about 20 BV/h, or about 30 BV/h.

Terms of degree such as “substantially”, “about” and “approximately” as used herein mean a reasonable amount of deviation of the modified term such that the end result is not significantly changed. Note that in the specification and claims, “about” or “approximately” means within twenty percent (20%) of the amount or value given.

As used in this disclosure, the singular forms “a”, “an”, and “the” include plural references unless the content clearly dictates otherwise. Measurements of concentration refer to an aqueous solution unless otherwise indicated by the specification or drawings.

The term “and/or” as used herein means that the listed items are present, or used, individually or in combination. These terms meant that “at least one of” or “one or more” of the listed items is present or used.

Although the invention has been described in detail with particular reference to the disclosed embodiments, other embodiments can achieve the same results. Variations and modifications of the present invention will be obvious to those skilled in the art and it is intended to cover all such modifications and equivalents. The entire disclosures of all references, applications, patents, and publications cited above and/or in the attachments, and of the corresponding application(s), are hereby incorporated by reference. Unless specifically stated as being “essential” above, none of the various components or the interrelationship thereof are essential to the operation of the invention. Rather, desirable results can be achieved by substituting various components and and/or reconfiguration of their relationships with one another.

What is claimed is:

1. A method for separating rare earth metals, the method comprising:
contacting a first plurality of rare earth metals with a first resin;
contacting the first plurality of rare earth metals with a first chelating agent;
separating the first plurality of rare earth metals into a second plurality of rare earth metals;
contacting the second plurality of rare earth metals with a second resin;
contacting the second plurality of rare earth metals with a second chelating agent; and
separating the second plurality of rare earth metals into individual rare earth metals.

2. The method of claim 1 wherein at least one of the plurality of rare earth metals comprises a light rare earth metal.

3. The method of claim 1 wherein at least one of the individual rare earth metals comprises a light rare earth metal.

4. The method of claim 1 wherein at least one of the plurality of rare earth metals comprises a medium rare earth metal.

5. The method of claim 1 wherein at least one of the individual rare earth metals comprises a medium rare earth metal.

6. The method of claim 1 wherein at least one of the plurality of rare earth metals comprises a heavy rare earth metal.

7. The method of claim 1 wherein at least one of the individual rare earth metals comprises a heavy rare earth metal.

8. The method of claim 1 wherein the first plurality of rare earth metals is separated into light and heavy rare earth metals.

9. The method of claim 8 wherein the first plurality of rare earth metals is separated into medium rare earth metals.

10. The method of claim 1 wherein the first resin is in communication with the second resin.

11. The method of claim 1 wherein the first resin is part of a primary carousel system.

12. The method of claim 1 wherein the second resin is part of a secondary carousel system.

13. The method of claim 1 wherein the first chelating agent comprises ethylenediaminetetraacetic acid.

14. The method of claim 1 wherein the second chelating agent comprises ethylenediaminetetraacetic acid.

15. A method for extracting rare earth metals, the method comprising:
contacting a solution comprising a rare earth metal with a primary amine resin;
contacting the solution with a cation resin;
contacting the solution with an N,N,N′,N′-tetra-n-octyldiglycolamine resin; and
extracting a rare earth metal from the N,N,N′,N′-tetra-n-octyldiglycolamine resin.

16. The method of claim 15 wherein the cation resin is a strong acid cation resin.

17. The method of claim 15 further comprising extracting uranium from the primary amine resin.

18. The method of claim 15 further comprising extracting thorium from the primary amine resin.

19. The method of claim 15 further comprising extracting aluminum from the cation resin.

20. The method of claim 15 further comprising extracting a monovalent metal ion from the cation resin.

21. The method of claim 15 further comprising separating impurities from the rare earth metals.

22. The method of claim 15 wherein the primary amine resin comprises a quaternary amine group.

23. The method of claim 15 wherein the N,N,N′,N′-tetra-n-octyldiglycolamine resin has an efficiency of at least 80%.

24. The method of claim 15 further comprising eluting a rare earth metal from the N,N,N′,N′-tetra-n-octyldiglycolamine resin.

25. The method of claim 15 further comprising extracting a metal from the primary amine resin.

26. The method of claim 25 wherein the metal comprises hafnium.

27. A method for extracting a metal, the method comprising:
at least partially disposing a material into a first cavity of a dynamic pad;
contacting the material at least partially disposed within the first cavity of the dynamic pad with an acid;
extracting a rare earth metal from the material at least partially disposed within the first cavity of the dynamic pad;
at least partially disposing the material into a second cavity of the dynamic pad;
contacting the material at least partially disposed within the second cavity of the dynamic pad with the acid; and
extracting a rare earth metal from the material at least partially disposed within the second cavity of the dynamic pad.

28. The method of claim 27 further comprising at least partially disposing the material in a permanent pad.

29. The method of claim 28 further comprising contacting the material at least partially disposed within the permanent pad with the acid.

30. The method of claim 29 further comprising extracting lithium from the material at least partially disposed within the permanent pad.

31. The method of claim 27 wherein the rare earth metal is extracted into a reclamation pond.

32. The method of claim 30 wherein the lithium is extracted into a reclamation pond.

33. The method of claim 28 wherein the dynamic pad is in communication with the permanent pad.

34. The method of claim 27 further comprising flowing the acid from the second cavity of the dynamic pad to the first cavity of the dynamic pad.

35. The method of claim 28 further comprising flowing the acid from the permanent pad to the second cavity of the dynamic pad.

36. The method of claim 27 wherein the material at least partially disposed in the first cavity of the dynamic pad is contacted with the acid for approximately 1 to 30 days.

37. The method of claim 27 wherein the material at least partially disposed in the second cavity of the dynamic pad is contacted with the acid for approximately 1 to 90 days.

38. The method of claim 28 wherein the material at least partially disposed in the permanent pad is contacted with the acid for approximately 1 to 120 days.

39. A method for separating lithium, the method comprising:
contacting an acid extraction product with a selective membrane to form a metal ion and hydrogen ion product;
precipitating aluminum from the metal ion and hydrogen ion product;
adjusting a pH value of the metal ion and hydrogen ion product to form a metal ion solution;
contacting the metal ion solution with a lithium-selective sorbent; and
forming a lithium ion solution.

40. The method of claim 39 further comprising contacting the metal ion and hydrogen ion product with a caustic.

41. The method of claim 39 further comprising concentrating the metal ion solution.

42. The method of claim 39 further comprising separating a rare earth metal from the metal ion and hydrogen ion product.

43. The method of claim 39 wherein the metal ion and hydrogen ion product comprises lithium.

44. The method of claim 39 further comprising contacting the metal ion and hydrogen ion product with a hydrogen ion-selective membrane.

45. The method of claim 44 further comprising contacting the hydrogen ion with the acid extraction product.

46. A method for precipitating aluminum, the method comprising:
concentrating a solution comprising lithium, aluminum, and sulfate;
crystallizing the solution;
precipitating aluminum;
forming a precipitation effluent comprising lithium; and
separating the precipitation effluent from the precipitated aluminum.

47. The method of claim 46 wherein the concentrating comprises evaporating.

48. The method of claim 46 wherein aluminum precipitates as aluminum sulfate.

49. The method of claim 46 wherein the crystallizing comprises decreasing the temperature of the solution.

50. The method of claim 49 wherein the temperature is decreased to a temperature of approximately 2° C. to 10° C.
